(19) United States
(12) Patent Application Publication
(10) Pub. No.: US 2008/0300019 A1
(43) Pub. Date: Dec. 4, 2008

(54) CELLULAR PHONE

(75) Inventor: Yoshihiro SUGIMOTO, Kanagawa-Ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/110,610

(22) Filed: Apr. 28, 2008

(30) Foreign Application Priority Data
May 31, 2007 (JP) P2007-145302

(51) Int. Cl. H04M 1/00

(52) U.S. Cl. 455/558

(57) ABSTRACT

According to one embodiment, the cellular phone includes a CPU, a RAM, a ROM, a network connection section, a NVRAM, and a UIM control unit. The CPU controls the operation of the cellular phone according to a program stored in the ROM. The CPU loads a replacement information registration program and data necessary to execute the program stored in the ROM into the RAM. According to the replacement information registration program, the CPU executes a processing for surely performing a database registration even if an electric power is shut off after a UIM card replacement determination is performed and before a database registration is performed.

### CROSS-REFERENCE TO RELATED APPLICATIONS

This application claims the benefit of priority of Japanese Patent Application No. 2007-145302, filed May 31, 2007, the entire contents of which are incorporated herein by reference.

### BACKGROUND

1. Field

The present invention relates to a cellular phone that uses data in an IC card such as a UIM card.

2. Description of the Related Art

Some cellular phones use data, such as a telephone number, stored in an IC card (hereinafter referred to as UIM card) such as a UIM card and a SIM card that is inserted into the cellular phones (for example, see Japanese Unexamined Patent Application Publication No. 2007-66159).

Such a type of the cellular phones, at the time of power activation, performs a determination (UIM card replacement determination) whether a UIM card that was inserted in previous power activation is the same as a UIM card that is currently being inserted. If it is determined that the UIM card has been replaced, the cellular phone registers (hereinafter, referred to as database registration) information (for example, an ID of the UIM card) about the UIM card associated with information (for example, an ID of the cellular phone) about the cellular phone in a database in a predetermined server via a network. The server associates the information about the cellular phone and the information about the IC card being inserted into the cellular phone in a one-to-one relationship, registers the associated data, and performs a database management.

In the known UIM card replacement determination technique, a result of the UIM card replacement determination that is performed when power of a cellular phone is turned on is stored in a volatile recording medium such as a random access memory (RAM). Accordingly, after it is determined that a UIM card has been replaced, and before database registration is performed, if the electric power is shut off by removing a battery or the like, the determination result that the UIM card has been replaced is lost. In this case, in the next power activation, it is determined that the UIM card is the same card (not replaced). Then, it is not possible to register the current UIM card information in a database.

### SUMMARY OF THE INVENTION

The present invention has been made in view of the above, and accordingly it is an object of the present invention to provide a cellular phone, at the time of power activation, for example, even if an electric power is shut off after a determination of replacement of an IC card such as a UIM card is performed, and before database registration is performed, the cellular phone that can surely perform a database registration after the next power activation.

To solve the above problem, the cellular phone according to an aspect of the present invention is a cellular phone in which an IC card that records at least a telephone number can be inserted, and can perform a processing based on data stored in the IC card. The cellular phone includes a nonvolatile storage unit, a card replacement determination unit configured to determine, at the time of system activation, whether a currently inserted IC card is the same as an IC card that was inserted when the system was previously operated, and a control unit configured to instruct the nonvolatile storage unit to store an information that the currently inserted IC card is a replaced card if it is determined that the IC cards are not the same in the determination result, and configured to invalidate the information to the effect that the currently inserted IC card is the replaced card stored in the nonvolatile storage unit if a notification is received from an external server to the effect that an unique information about the cellular phone associated with an information about the currently inserted IC card is registered in a database in the server, the database registered the unique information about the cellular phone associated with the information about IC card.

Further, to solve the above problem, the cellular phone according to another aspect of the present invention is a cellular phone in which an IC card that records at least a telephone number can be inserted, and can perform a processing based on data stored in the IC card. The cellular phone includes a storage unit, a determination unit configured to determine, if a power switch is activated, whether a currently inserted IC card is the same as an IC card that was inserted when the cellular phone was previously operated, and a control unit configured to instruct the storage unit to store an information that the currently inserted IC card is a replaced card if it is determined that the IC cards are not the same in the determination result, and configured to invalidate the information to the effect that the currently inserted IC card is the replaced card stored in the storage unit if a notification is received from a network to the effect that an unique information about the cellular phone associated with an information about the currently inserted IC card is registered in a database connected in the network, the database registered the unique information about the cellular phone associated with the information about IC card.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic structural view illustrating a cellular phone according to an embodiment of the present invention;

FIG. 2 is a flowchart illustrating a procedure in surely performing a database registration using a CPU in the cellular phone illustrated in FIG. 1 after the next power activation even if an electric power is shut off after a UIM card replacement determination is performed and before a database registration is performed;

FIG. 3 is a view illustrating a sequence in performing a database registration of UIM card replacement information in a case where the UIM card replacement determination result is stored in a volatile storage medium such as a RAM;

FIG. 4 is a view illustrating a database registration sequence in a case where a system is restarted after a UIM card replacement determination is performed and before a database registration is performed in a case where UIM card replacement determination result is stored in a volatile storage medium such as a RAM; and

FIG. 5 is a view illustrating a database registration sequence in a case where the cellular phone according to the embodiment of the present invention is restarted after a UIM card replacement determination is performed and before a database registration is performed.

### DETAILED DESCRIPTION

Hereinbelow, a description will be given of a cellular phone, according to an embodiment of the present invention with reference to the drawings.

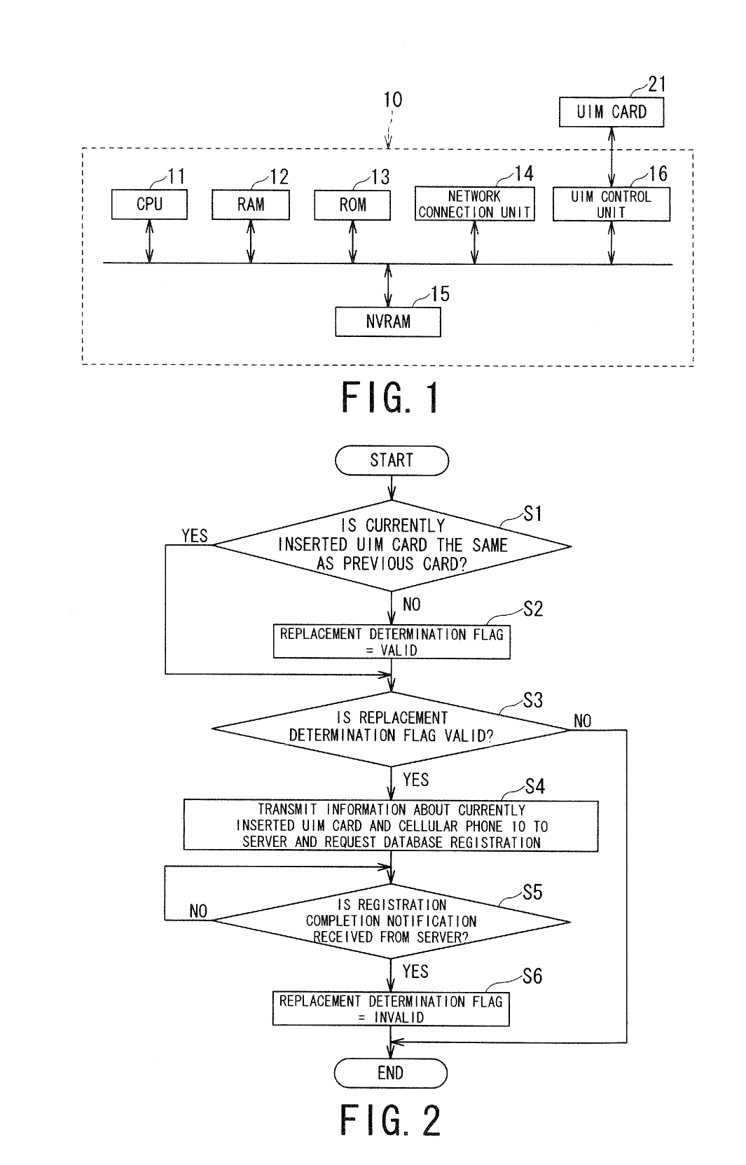

FIG. 1 is a schematic structural view illustrating a cellular phone 10 according to an embodiment of the present invention.

The cellular phone 10 includes a CPU 11, a RAM 12, a ROM 13, a network connection unit 14, a NVRAM 15, and a UIM control unit 16.

The CPU 11 controls the operation of the cellular phone 10 following a program stored in the ROM 13. The CPU 11 loads a replacement information registration program and data necessary to execute the program stored in the ROM 13 into the RAM 12. According to the replacement information registration program, the CPU 11 executes processing for surely performing a database registration even if an electric power is shut off after a determination of replacement of the UIM card 21 is performed and before a database registration is performed.

The RAM 12 provides a work area to temporarily store programs executed by the CPU 11 and data.

The ROM 13 stores a boot program of the cellular phone 10, a replacement information registration program, and various types of data for executing these programs.

The ROM 13 may have a configuration that includes a recording medium that can be read by the CPU 11 such as a magnetic or optical recording medium, a semiconductor memory, or the like. Further, a part or whole of the programs and data in the ROM 13 may be downloaded via an electronic network.

In the network connection unit 14, various information communication protocols corresponding to network configurations are mounted. The network connection unit 14 connects the cellular phone 10 to an electronic network according to the various protocols. The electronic network denotes information communication networks in general that use electric communication techniques, and includes telephone communication networks, wireless/wired local area networks (LANs), internet networks, or the like.

The NVRAM 15 stores a replacement determination flag that indicates whether the UIM card 21 currently being inserted is a replaced card or not. A default value of the replacement determination flag is invalid, and in a case where the currently inserted UIM card 21 is the replaced card, the replacement determination flag is changed to valid.

The replacement determination flag that is once changed to valid is considered as invalid only in a case where the cellular phone 10 receive information to the effect that information about the cellular phone 10 is associated with information of the currently inserted UIM card 21 and the associated data is registered. Accordingly, by simply referring to the replacement determination flag, it is possible to know whether the associated data has been registered in the database or not. For example, if the replacement determination flag is valid, information to be registered in the database still exists.

The NVRAM 15 is a nonvolatile storage medium that can hold stored information after an electric power of the cellular phone 10 is shut off, and has a configuration that includes a recording medium that can be read and written by the CPU 11. As the NVRAM 15, for example, an EEPROM or the like can be used.

The CPU 11, according to the replacement information registration program, functions as a card replacement determination unit, a flag determination unit, a registration request unit, and a reception determination unit. The CPU 11 also functions as a replacement information write unit and a replacement information deletion unit as a replacement information control unit. These units use a predetermined work area in the RAM 12 as temporary storage for data. These units may be configured of hardware logic without using the CPU 11.

Now, an example of operation of the cellular phone 10 according to the embodiment is described. FIG. 2 is a flowchart illustrating a procedure in surely performing a database registration using the CPU 11 in the cellular phone 10 illustrated in FIG. 1 after the next power activation even if an electric power is shut off after a replacement determination of the UIM card 21 is performed and before a database registration is performed. In FIG. 2, the reference numerals with the letter S indicate the steps in the flowchart. The procedure starts at the time a power of the cellular phone 10 is turned on.

In step S1, the card replacement determination unit determines whether a currently inserted UIM card 21 is the same as a UIM card 21 in a previous activation. If the cards are not the same cards, that is, the cards are replaced with each other, the processing proceeds to step S2. On the other hand, if the cards are the same card, the processing proceeds to step S3.

A card replacement determination method performed by the card replacement determination unit is briefly described. Data in the UIM card 21 has a directory structure. When the UIM card 21 is inserted into the cellular phone 10 and once a card replacement determination is performed, a pointer, that located at an initial position at the time right after the insertion, keeps a state that the pointer has moved to a predetermined directory. Accordingly, by simply checking whether the pointer is located at the initial position or not, it is possible to know whether the UIM card 21 had a card replacement determination at least once in the past.

If a loose connection due to a shock occurs during the insertion of the UIM card 21, while the appearance viewed by a user is not changed and the card is still inserted, the pointer may return to the initial position. Accordingly, after the determination whether the pointer is located at the initial position is performed, and if the pointer is located at the initial position, an ID of the UIM card 21 is checked. The ID of the NVRAM card 21 can be stored in the NVRAM 15 or the like in step S1, i.e., in the card replacement determination at the power activation. By checking the ID stored in the NVRAM 15 and the ID of the UIM card 21 (newly inserted, or looks like as if newly inserted due to the loose connection, etc.) whose pointer is located at the initial position, a correct card replacement determination can be performed.

Then, if the card replacement determination unit determines that the card has been replaced, in step S2, the replacement information write unit validates a replacement determination flag of the NVRAM 15.

Then, in step S3, the flag determination unit determines whether the replacement determination flag stored in the NVRAM 15 is valid or not. If the replacement determination flag is valid, the processing proceeds to step S4. On the other hand, if the replacement determination flag is invalid, there is no information to be registered in a database in a server. Then, the series of processing is ended.

In step S4, the registration request unit transmits information about the currently inserted UIM card 21 and the cellular phone 10 to the server, and requests the server to register the information in the database. The information about the UIM card 21 and the cellular phone 10 includes at least the ID of the UIM card 21, and the ID of the cellular phone 10, respectively.

In step 5, the reception determination unit determines whether a notification (hereinafter, referred to as registration completion notification) from the server is received or not to the effect that the information transmitted from the server by the registration request unit is registered in the database. If the registration completion notification is received, the processing proceeds to step S6. On the other hand, if the registration completion notification is not received, monitoring of the reception of the registration completion notification is continued.

In step S6, the replacement information deletion unit receives information that the registration completion notification is received from the server from the reception determination unit, and invalidates the replacement determination flag stored in the NVRAM 15.

According to the above-described procedure, even in the case that the power is shut off after the replacement determination of the UIM card 21 is performed and before the database registration is performed (in the flowchart in FIG. 2, in the case the power is shut off after the processing of the determination in step S1 to the processing of the reception of the registration completion notification from server in step S5), after the next power activation, the database registration can be surely performed by using the replacement determination flag.

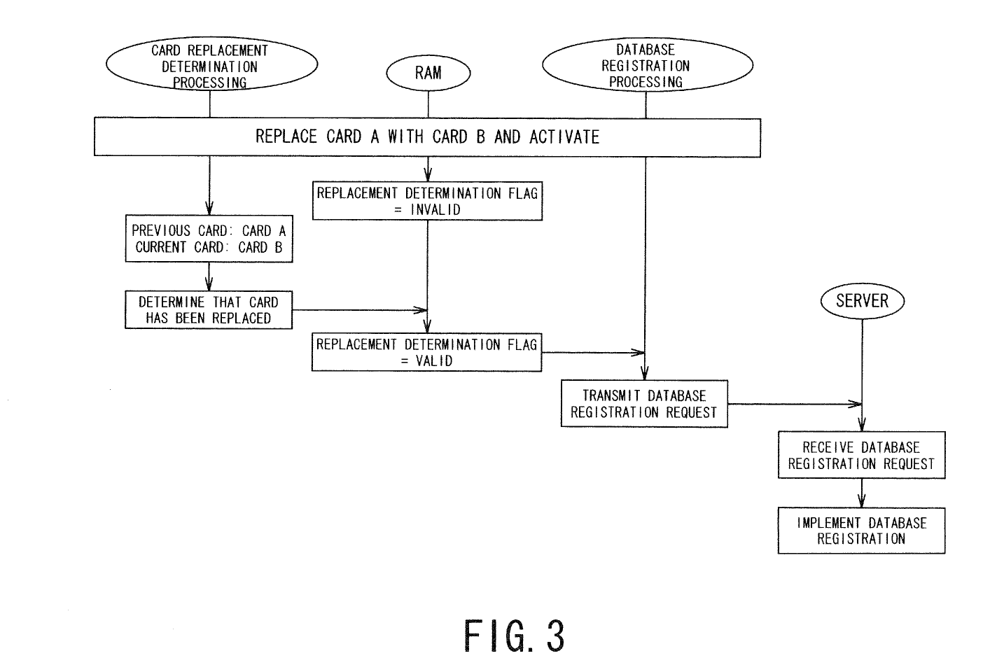

Now, as an example that the UIM card 21 is replaced, a database registration procedure in a case where a UIM card 21A is replaced with a UIM card 213 is briefly described with reference to FIGS. 3 to 5.

FIG. 3 is a view illustrating a sequence in performing a database registration of replacement information of the UIM card 21 in a case where the replacement determination result of the UIM card 21 is stored in a volatile storage medium such as a RAM.

As illustrated in FIG. 3, in the case where the replacement determination result of the UIM card 21 is stored in the volatile storage medium such as the RAM 12, if the power is not shut off after the replacement determination of the UIM card 21 is performed and before the database registration is performed, the database registration can be completed without problems.

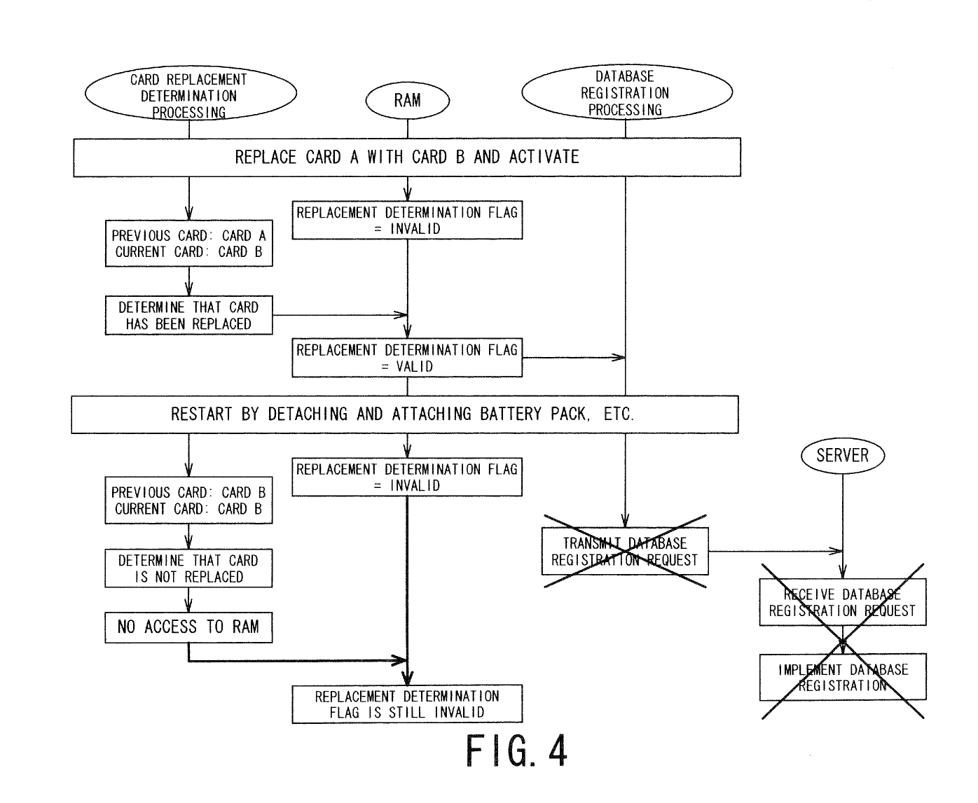

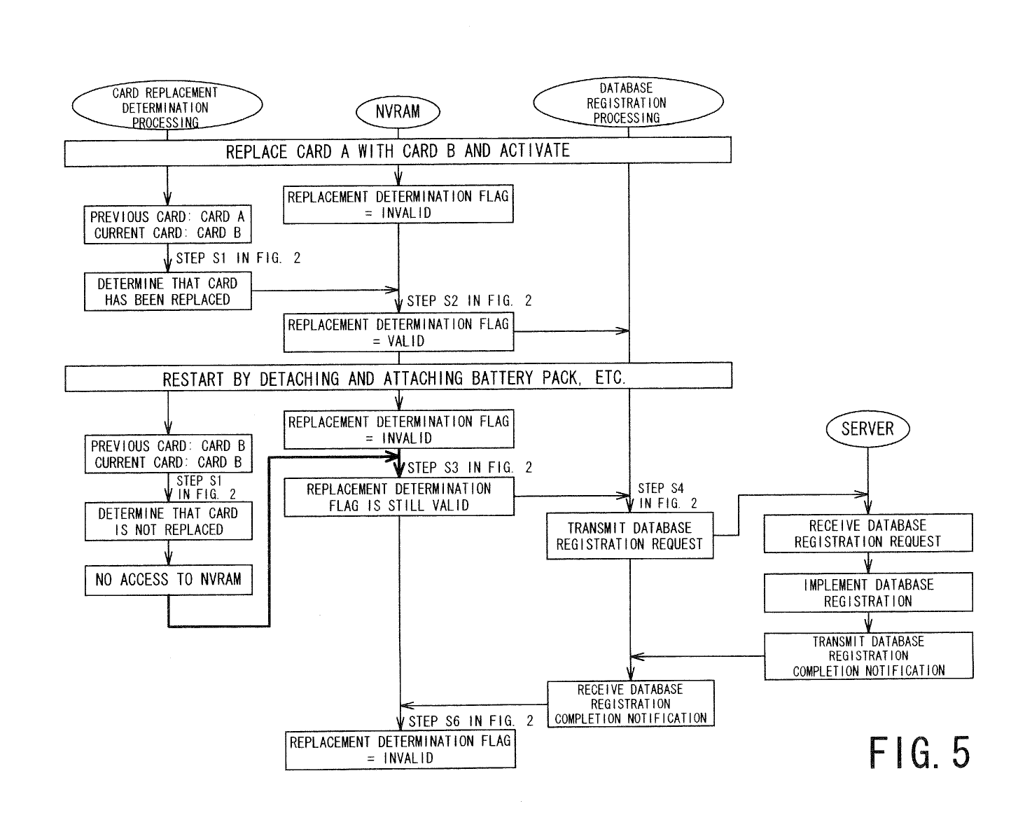

FIG. 4 is a view illustrating a database registration sequence in a case where a system is restarted after a replacement determination of the UIM card 21 is performed and before a database registration is performed in a case where the replacement determination result of the UIM card 21 is stored in a volatile storage medium such as a RAM.

If the power is shut off, the volatile storage medium cannot store the storage contents including the replacement determination result. Accordingly, as illustrate in FIG. 4, if the system is restarted by detaching and attaching a battery pack or the like, the replacement determination result that denotes the replacement has been performed is lost from the volatile storage medium, and the replacement determination flag becomes invalid.

As illustrated in FIG. 4, in response to the restart of the system, the card replacement determination unit determines again whether the UIM card 21B that was inserted before the restart is the same as the currently inserted UIM card 21B or not. As a result, the card replacement determination unit determines that the cards are the same and the card is not replaced. Accordingly, after the restart, the replacement information write unit does not access to the volatile storage medium, and the replacement determination flag is kept as invalid.

Accordingly, as illustrated in FIG. 4, in the known technique that the replacement determination result of the UIM card 21 is stored in the volatile storage medium such as the RAM, if the system is restarted after the replacement determination of the UIM card 21 is performed and before the database registration is performed, it is not possible to register the replacement determination result.

FIG. 5 is a view illustrating a database registration sequence in a case where the cellular phone 10 according to the embodiment of the present invention is restarted after a replacement determination of the UIM card 21 is performed and before a database registration is performed.

As illustrated in FIG. 5, the cellular phone 10 stores a replacement determination result in the NVRAM 15 that is a nonvolatile storage medium. Accordingly, if the system is restarted by detaching and attaching a battery pack or the like, the NVRAM 15 keeps the replacement determination flag as valid.

Similarly to the example illustrated in FIG. 4, in the example illustrated in FIG. 5, in response to the restart of the system, the card replacement determination unit determines again whether the UIM card 21B that was inserted before the restart is the same as the currently inserted UIM card 21B or not (corresponding to step S1 in FIG. 2). As a result, the card replacement determination unit determines that the cards are the same and the card is not replaced. Accordingly, the replacement information write unit does not access to the NVRAM 15, and the replacement determination flag is kept as valid (corresponding to YES determination in step S1 in FIG. 2).

Accordingly, as illustrated in FIG. 5, the cellular phone 10 according to the embodiment of the present invention can surely perform the database registration of the replacement determination result in the database even if the cellular phone 10 is restarted after the replacement determination of the UIM card 21 is performed and before the database registration is performed.

The cellular phone 10 according to the embodiment of the present invention, in response to the detection of the replacement of the UIM card 21 in power activation, immediately validates the replacement determination flag in the NVRAM 15. Further, the replacement determination flag that is once validated is changed to invalid only in the case where the registration completion notification is received from the server. Accordingly, if the power is shut off after the replacement determination of the UIM card 21 is performed and before the database registration is performed, the replacement determination flag is kept as valid. In the cellular phone 10 according to the embodiment of the present invention, in the case the UIM card 21 is replaced, the database registration can be surely performed.

It is to be understood that the present invention is not limited to the above-described embodiment. At a practical stage, the structural elements can be modified and embodied without departing from the spirit and scope of the invention. Besides, it is possible to form inventions of various forms according to appropriate combinations of the plural elements disclosed in the embodiments. For example, several elements may be deleted from all the elements described in the embodiments.

What is claimed is:

1. A cellular phone in which an IC card that records at least a telephone number can be inserted, and can perform a processing based on data stored in the IC card, the cellular phone comprising:
a nonvolatile storage unit;
a card replacement determination unit configured to determine, at the time of system activation, whether a currently inserted IC card is the same as an IC card that was inserted when the system was previously operated; and
a control unit configured to instruct the nonvolatile storage unit to store an information that the currently inserted IC card is a replaced card if it is determined that the IC cards are not the same in the determination result, and configured to invalidate the information to the effect that the currently inserted IC card is the replaced card stored in the nonvolatile storage unit if a notification is received from an external server to the effect that an unique information about the cellular phone associated with an information about the currently inserted IC card is registered in a database in the server, the database registered the unique information about the cellular phone associated with the information about IC card.

2. The cellular phone according to claim 1, further comprising:
a registration request unit configured to send the information about the currently inserted IC card and the unique information about the cellular phone to the server, and configured to request the server to register the informations to be associated with each other in the database if the information to the effect that the currently inserted IC card is the replaced card is stored in the nonvolatile storage unit.

3. The cellular phone according to claim 1, wherein the unique information about the cellular phone and the information about the IC card includes at least an ID of the cellular phone and an ID of the IC card respectively.

4. The cellular phone according to claim 1, wherein the nonvolatile storage unit further stores an ID of the IC card that was inserted when the system was previously operated.

5. A cellular phone in which an IC card that records at least a telephone number can be inserted, and can perform a processing based on data stored in the IC card, the cellular phone comprising:
a storage unit;
a determination unit configured to determine, if a power switch is activated, whether a currently inserted IC card is the same as an IC card that was inserted when the cellular phone was previously operated; and
a control unit configured to instruct the storage unit to store an information that the currently inserted IC card is a replaced card if it is determined that the IC cards are not the same in the determination result, and configured to invalidate the information to the effect that the currently inserted IC card is the replaced card stored in the storage unit if a notification is received from a network to the effect that an unique information about the cellular phone associated with an information about the currently inserted IC card is registered in a database connected in the network, the database registered the unique information about the cellular phone associated with the information about IC card.

6. The cellular phone according to claim 5, further comprising:
a registration request unit configured to send the information about the currently inserted IC card and the unique information about the cellular phone to the network, and configured to request the network to register the informations to be associated with each other in the database if the information to the effect that the currently inserted IC card is the replaced card is stored in the storage unit.

7. The cellular phone according to claim 5, wherein the unique information about the cellular phone and the information about the IC card includes at least an ID of the cellular phone and an ID of the IC card respectively.

8. The cellular phone according to claim 5, wherein the storage unit further stores an ID of the IC card that was inserted when the cellular phone was previously operated.
